(19) United States
(12) Patent Application Publication
(10) Pub. No.: US 2008/0040383 A1
(43) Pub. Date: Feb. 14, 2008

(54) Electronic device, computer program product, and data ranking method

(75) Inventors: Hiromi Kuwata, Tokyo (JP); Shoei Nakamura, Yokohama-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/882,204

(22) Filed: Jul. 31, 2007

(30) Foreign Application Priority Data
Aug. 4, 2006 (JP) 2006-213027

(51) Int. Cl. G06F 17/30

(52) U.S. Cl. 707/102; 707/E17.005

(57) ABSTRACT

An electronic device includes: a comment appending unit that appends a desired comment to each of a plurality of rankings prepared for assigning a ranking to a data item; and a correspondence establishment unit that establishes correspondence between the data item, and one of the plurality of rankings and the comment corresponding to the one of the plurality of rankings.

### INCORPORATION BY REFERENCE

The disclosure of the following priority application is herein incorporated by reference:

Japanese Patent Application No. 2006-213027 filed Aug. 4, 2006.

### BACKGROUND OF THE INVENTION

1. Field of the Invention

The present invention relates to an electronic device, a computer program product, and a data ranking method, that are capable of assigning rankings to data such as image files or the like.

2. Description of Related Art

In Japanese Laid-Open Patent Publication 2004-246868, there is described a method for setting a value evaluated by a user (termed “a level of appreciation”) to each of a plurality of items of image data. If values evaluated in advance are set to each of a plurality of items of image data, then the task of creating an album by extracting, for example, only those items of image data for which the evaluation is greater than some level, can be performed in a simple manner, and such an album can be created in a short time period, even if the amount of image data is very large.

### SUMMARY OF THE INVENTION

The evaluation of items of data and the assignment of rankings to them has more than one aspect. For example, in the case of image data, rather than simple evaluation of the overall level of excellence, sometimes it may be desired to perform a specialized evaluation of their focus or their exposure. In this type of case, when the evaluation of the data has been displayed, it is necessary for the viewer to be able to know immediately from what aspect the evaluation thereof has been performed. In Reference Document #1 where evaluation is only simply performed according to “level of appreciation”, no consideration is accorded to this aspect of the matter.

According to the 1st aspect of the present invention, an electronic device comprises: a comment appending unit that appends a desired comment to each of a plurality of rankings prepared for assigning a ranking to a data item; and a correspondence establishment unit that establishes correspondence between the data item, and one of the plurality of rankings and the comment corresponding to the one of the plurality of rankings.

According to the 2nd aspect of the present invention, in the electronic device according to the 1st aspect, it is preferred that: there is further provided a category of evaluation designation unit that designates, for the data item, a category of evaluation for which a plurality of rankings can be assigned; and the comment appending unit appends the comment to each of the rankings of this designated category of evaluation.

According to the 3rd aspect of the present invention, in the electronic device according to the 1st aspect, it is preferred that: there is further provided a category of evaluation designation unit that designates, for the data item, a plurality of categories of evaluation for each of which a plurality of rankings can be assigned; and the comment appending unit appends the comment to each of the rankings of each of these designated categories of evaluation.

According to the 4th aspect of the present invention, in the electronic device according to the 1st aspect, it is preferred that the data item to which the ranking can be assigned is a file that can be handled by a computer.

According to the 5th aspect of the present invention, in the electronic device according to the 1st aspect, it is preferred that the comment appending unit appends the desired comment as text according to text input from the user.

According to the 6th aspect of the present invention, in the electronic device according to the 1st aspect, it is preferred that the comment appending unit appends the desired comment as an icon according to designation of an icon from the user.

According to the 7th aspect of the present invention, in the electronic device according to the 1st aspect, it is preferred that there is further provided a display unit that displays information specifying the data item, the ranking established in correspondence with the data item, and the comment appended to the ranking.

According to the 8th aspect of the present invention, in the electronic device according to the 3rd aspect, it is preferred that there is further provided a display unit that displays information specifying the data item, the plurality of categories of evaluation designated for the data item, and the rankings established in correspondence with each of the plurality of categories of evaluation.

According to the 9th aspect of the present invention, a computer-readable computer program product contains a ranking assignment program. The ranking assignment program comprises: a first instruction that appends a desired comment to each of a plurality of rankings prepared for assigning a ranking to a data item; and a second instruction that establishes correspondence between the data item, and one of the plurality of rankings and the comment corresponding to the one of the plurality of rankings.

According to the 10th aspect of the present invention, in the computer program product according to the 9th aspect, it is preferred that: the computer program further comprises a third instruction that designates, for the data item, a category of evaluation for which a plurality of rankings can be assigned; and the second instruction appends the comment to each of the rankings of this designated category of evaluation.

According to the 11th aspect of the present invention, in the computer program product according to the 9th aspect, it is preferred that: the computer program further comprises a third instruction that designates, for the data item, a plurality of categories of evaluation for each of which a plurality of rankings can be assigned; and the second instruction appends the comment to each of the rankings of each of these designated categories of evaluation.

According to the 12th aspect of the present invention, a method of data ranking used in an electronic device, comprises: appending a desired comment to each of a plurality of rankings prepared for assigning a ranking to a data item; and establishing correspondence between the data item, and one of the plurality of rankings and the comment corresponding to the one of the plurality of rankings.

### BRIEF DESCRIPTION OF THE DRAWINGS

FIG. 1 is a structural diagram of a computer system that is an embodiment of the present invention;

FIGS. 2A through 2D are figures for explanation of evaluation categories, rankings, and rating comments;

FIG. 3 is a figure showing an example of a display of files accompanied by rankings and rating comments;

FIG. 4 is a flow chart showing an example of processing for assigning rating comments to rankings;

FIG. 5 is a flow chart showing an example of processing for establishing a correspondence between rankings and rating comments, and files;

FIG. 6 is a figure showing an example of a display screen when the processing of FIG. 4 is being performed, and shows an initial screen;

FIG. 7 is a similar figure to FIG. 6, and shows a screen that uses rating comments that are already registered;

FIG. 8 is a similar figure to FIG. 6, and shows a screen on which a rating comments can be selected or inputted;

FIG. 9 is a similar figure to FIG. 6, and shows a screen on which icon files are selected as rating comments;

FIGS. 10A through 10C are figures showing examples in which a plurality of categories of evaluation are specified for each of a plurality of single files, and the results of ranking assignment thereto are displayed as lists;

FIG. 11 is a figure showing an example of a display for selecting one of a plurality of categories of evaluation; and

FIG. 12 is a figure showing a situation in which a program is supplied to a computer.

### DESCRIPTION OF THE PREFERRED EMBODIMENTS

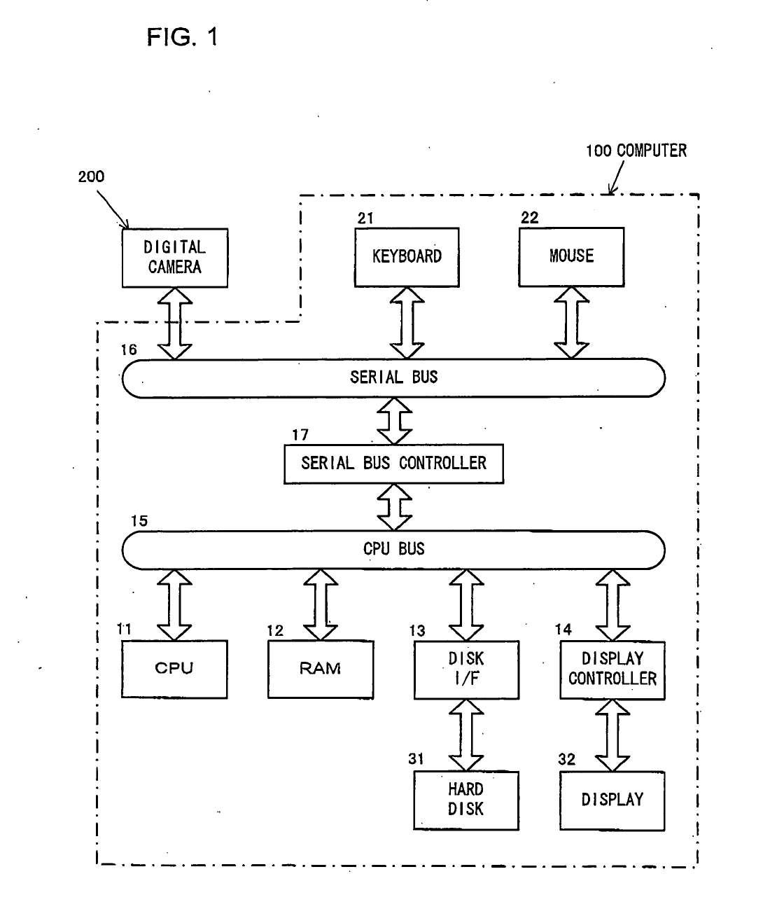

An embodiment in which the present invention is applied to a program for a computer will now be explained with reference to FIGS. 1 through 9.

As shown in FIG. 1, a computer 100 includes a main body portion that includes a CPU 11, a RAM 12, a disk interface 13, a display controller 14, a CPU bus 15, a serial bus 16, and a serial bus controller 17 and the like, input devices such as a keyboard 21 and a mouse 22 and so on that are connected via the serial bus 16, a hard disk that is connected via the disk interface 13, and a display 32 that functions as a display device. This computer 100 may be a personal computer, a work station, or a general purpose computer.

A digital camera 200 can be connected to the computer 100 via the serial bus 16. Image files that are recorded upon a recording medium of the camera 200 may be transferred to the computer 100 by using predetermined software, and may be stored upon the hard disk 31.

The assignment of rankings to image files will now be explained.

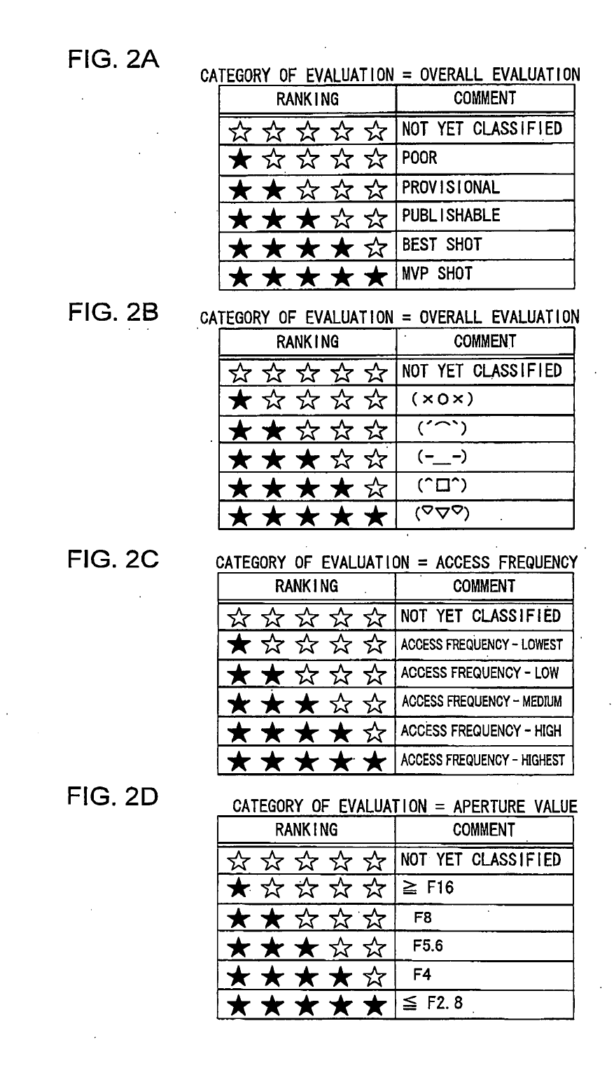

The user is able to perform assignment of rankings to each of a plurality of items of image data that are stored upon the hard disk 31 from various points of view. As shown in FIGS. 2A through 2D, irrespective of the category of evaluation, this ranking assignment is performed using a number of pentagram signs: each evaluation is indicated by a number of black colored stars (from zero stars to five stars). Since a plurality of categories for evaluation may be set, accordingly it is not possible to know for what reason an evaluation has been made, only from the number of stars. Therefore it is arranged to be able, for each category of evaluation, to append a comment to each ranking (number of stars) freely. In the following, these comments appended to the rankings will be termed rating comments.

For example FIG. 2A shows an evaluation setting for evaluating the overall quality of images: for each number of stars from one star to five stars, a rating comment is set with corresponding text. Here the greater is the number of stars, the higher is the evaluation. And FIG. 2B shows a similar type of overall evaluation, but in this case designs (icons) are used, instead of text comments. Such icons also are considered as being included in the concept of rating comments.

The evaluation of the image files is not limited to overall evaluation: for example, it is also possible to set, as the category of evaluation, evaluation in which attention is only paid to the state of focus, or evaluation in which attention is only paid to the state of exposure, or evaluation in which attention is only paid to the level of blur due to camera vibration; and, in each case, it is possible to set a number of stars and a rating commend for each category of evaluation.

Furthermore sometimes, for some categories of evaluation, the computer 100 may perform the task of assignment of ranking automatically. FIG. 2C shows a case in which the image files are evaluated according to the frequencies at which they are accessed. The CPU 11 counts the number of times that each image file is opened, and determines the number of stars to be assigned to each image file automatically according to this number of accesses. Moreover, FIG. 2D shows an example in which ranking assignment for the image files is performed according to the aperture value that was used during photography. Each of the image files includes appended information other than the data for its main image, such as for example Exif information or the like, and their aperture values are recorded in this appended information. Thus, the CPU 11 extracts the aperture values by referring to this information appended to each of the image files, and determines a number of stars corresponding to this aperture value. Setting of rating comments for a category of evaluation that is employed in this type of automatic ranking assignment may also be performed.

The ratings and ranking comments that have been set are stored in correspondence with each category evaluation. When performing ranking assignment for a desired image file, the user first selects a category of evaluation, and then sets a ranking corresponding to this evaluation. By doing this, a number of stars and a rating comment corresponding thereto are set in correspondence to this image file, and are stored. Rankings and rating comments for a plurality of categories of evaluation may be set in correspondence to a single file. For example, in relation to some image file, a ranking assignment may be performed in which, although the state of focus is five stars, the overall evaluation is four stars.

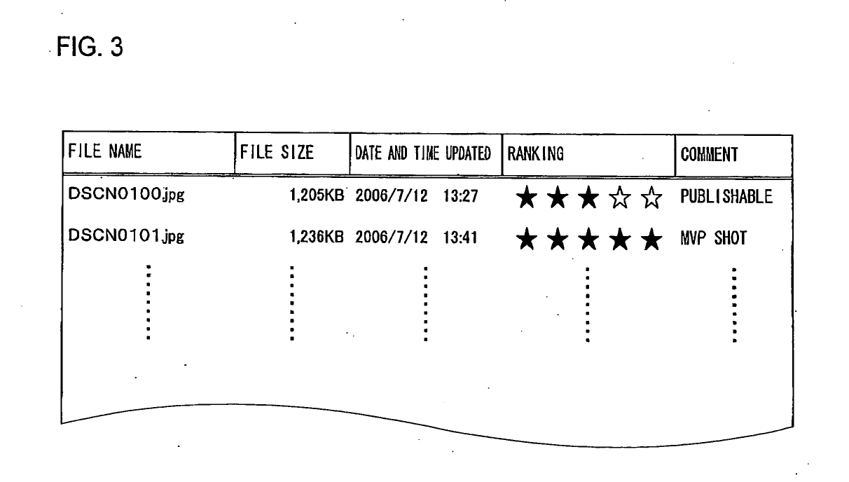

And, when displaying a list of the image files, the user is able to designate the category of evaluation described above. When this is done, as shown in FIG. 3, apart from the file name, the date of creation, the size and so on of each image file, along with the ranking corresponding to the category of evaluation that has been selected being displayed by the number of stars, also the rating comments corresponding to these rankings are displayed at the same time. Furthermore, if icon files are used as the rating comments, then these icons are displayed in the comments column. When the category of evaluation is changed, the rankings and rating comments are changed in correspondence to the changed category of evaluation. It should be understood that it is desirable to display the category of evaluation that is currently selected in each of these displays.

Furthermore, when displaying this list of image files, control can also be performed simply and easily to display, for example, only the image files that have five stars, or only those that have three or more stars.

Here, the image files that are the subject of ranking assignment may not only be those ones that have been photographed by the user himself, but may also be image files that have been acquired via a network or the like. Furthermore, the present invention is not limited to use with image files; it would also be acceptable to arrange for the subject of ranking assignment to be video files or audio files or the like. For these it would be possible to make the category of evaluation be, for example, the sampling rate or the bit rate or the like; and, as the rating comments, it would be possible to allocate highest picture quality (or sound quality), high picture quality (or sound quality), . . . , or the like. Moreover, the data that is the subject of ranking assignment is not limited to being files; for example, it would also be acceptable for this data to be individual addresses that are recorded in an electronic address notebook.

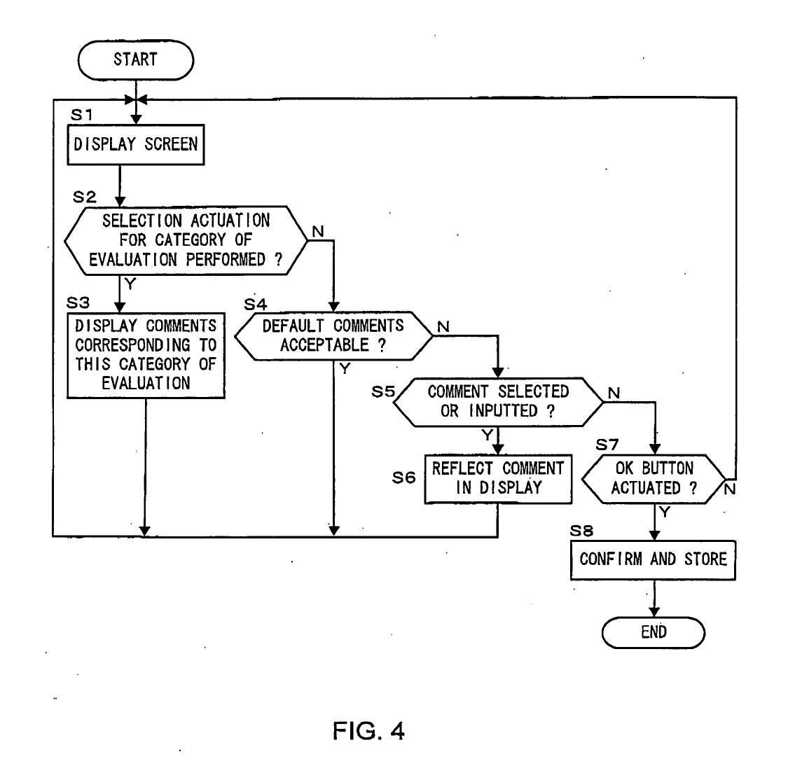

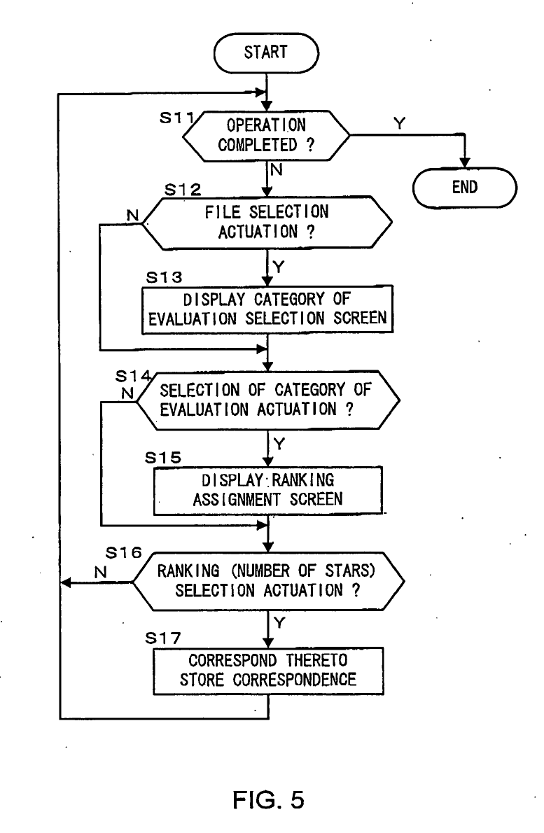

An example of a processing sequence for implementing the ranking assignment function described above is shown in FIGS. 4 and 5.

FIG. 4 shows an example of the processing steps for assigning rating comments to rankings; here, it is supposed that files are the subject of evaluation. This program may be supplied as one function of file management software that has been stored in advance upon the hard disk 31. In this case, it would also be acceptable to arrange for the correspondence of rating comments to be performed by units of the folders in which the files are stored. Furthermore, if only image files are the subject, then this function may be provided as one function of image viewer software or the like. In this case, it would also be acceptable to arrange to perform assignment of comments in units of albums that are made up by collecting together a plurality of image files.

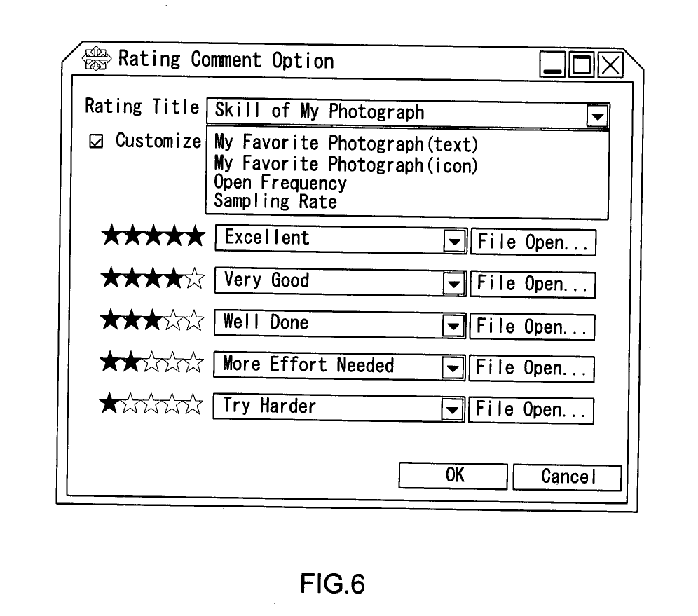

The CPU 11 starts the program of FIG. 4 upon a predetermined actuation, and, in the first step S1, an initial screen is displayed. An example of such an initial screen is shown in FIG. 6, upon which it is possible to set the category of evaluation (Rating Title) and rating comments. “Skill of My Photograph” and “My Favorite Photograph” and so on are categories of evaluation that a real ready registered as options, and the user is able to select any one from among these, or is also able to input an appropriate item as text if no available option appears to the user to be suitable. On the other hand, “Excellent” and “Very Good” and so on are rating comments that are already registered, and the user is also able to select anyone from among these, or is also able to input anew comment. It should be understood that it is desirable to prepare a number of default categories of evaluation and rating comments in advance. Moreover, it should be understood that the categories of evaluation and rating comments that are set with FIG. 6 can be applied to all of the folders or files that are managed by the OS of the computer 100.

When selection actuation or input of a category of evaluation is performed, the result of a decision in a step S2 becomes affirmative, and then in a step S3 any rating comments that are set are displayed by ranking. For example, if a category of evaluation that is already registered has been selected, then the rating comments that are set in correspondence with this category of evaluation are displayed; while, if a new category of evaluation has been inputted, then default rating comments may be displayed.

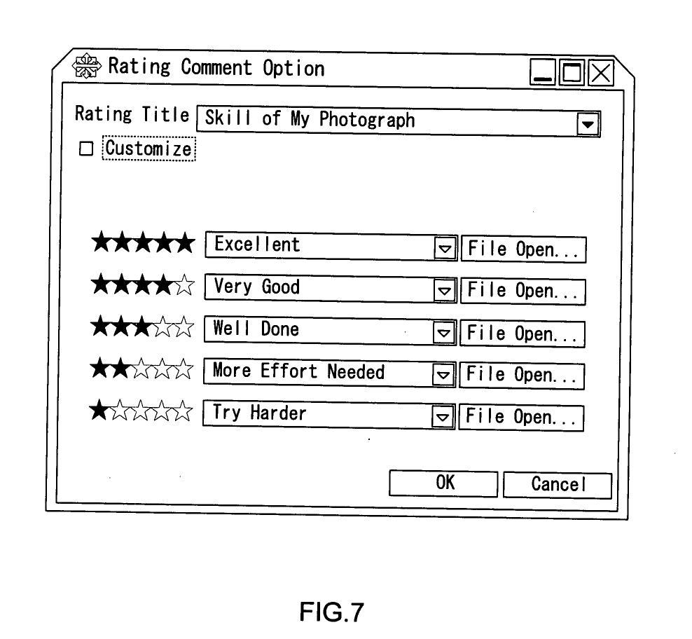

If the rating comments that are displayed are acceptable, then the user may press the OK button without further ado. On the other hand, if he wishes to change some rating comment, then he turns the check box “Customize” to ON. It should be understood that FIG. 7 shows the case in which the check box “Customize” is OFF, and in this case no rating comments can be selected or inputted.

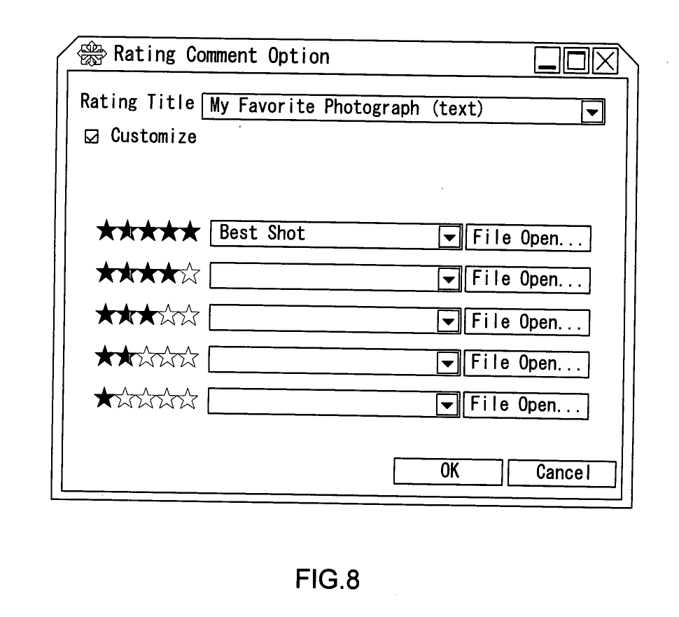

When the checkbox “Customize” is turned to ON, the result of a decision in a step S4 becomes negative, and, along with the default rating comments being deleted, a state is established in which rating comments may be selected or inputted (refer to FIG. 8). Here the user is able to select a rating comment from various options, and is also able to input any desired comment by using the keyboard 21. “Best Shot” in FIG. 8 is a comment that has been inputted by the user. Moreover, if the user desires to use an icon as a comment, he actuates the “File Open” button instead of inputting text. Upon doing this, a dialog box for file selection (not shown in the figures) is displayed, so that he is able to select an icon file.

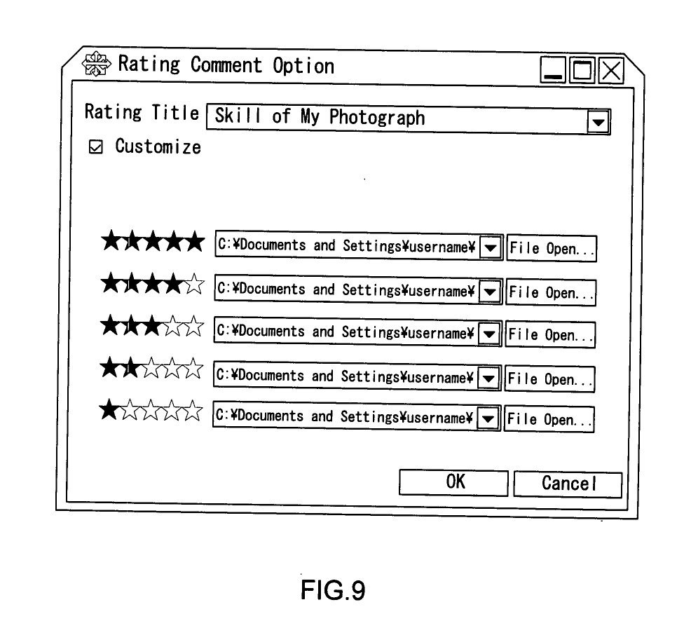

When the setting of a rating comment (any one of text selection, text input, or icon file selection) is confirmed in the step S5, then in a step S6 this setting is reflected in the display upon the screen. If selection of an icon file has been performed, then the file in this location (file path) is displayed (refer to FIG. 9). And, when in a step S7 actuation of the OK button is confirmed, then the combination of category of evaluation and rating comments that is displayed at this time is confirmed, and in a step S8 a correspondence is established between this category of evaluation and the rankings and rating comments, and is stored upon the hard disk 31. Thereafter, display of this screen is cancelled, and this sequence of processing terminates.

FIG. 5 shows an example of the processing steps for ranking assignment processing, and this also may be supplied as one function of software that has been explained before. Upon actuation for starting this processing, the CPU 11 starts this program; and it repeats the processing from the step S12 onwards until the end of program operation is confirmed in a step S11. When in the step S12 file selection actuation is confirmed, in a step S13 the file that has been selected is set as the subject file for processing, and a screen for selecting the category of evaluation for this file is displayed.

When in a step S14 selection actuation for some category of evaluation is confirmed, then in a step S15 a ranking assignment screen is displayed for performing ranking assignment for this category of evaluation. For example, along with numbers of stars from zero to five being displayed upon the screen, rating comments corresponding respectively thereto are displayed, and it is made possible for the user to select any one of these with the mouse. These rating comments are ones that correspond to the category of evaluation in the processing of FIG. 4 as described above. It should be understood that a number of stars of zero means “not yet evaluated”, and initially this setting is established for all of the files.

When the fact that a ranking has been selected is confirmed in a step S16, next in a step S17 the ranking that has been selected and the rating comment that corresponds thereto are stored in correspondence with this file. The ranking and rating comment that have thus been established in correspondence with the file are reflected in the file list display, like the one shown by way of example in FIG. 3.

According to the above, when ranking assignment has been performed for an image file (data), it becomes possible for the user to know in a simple and easy manner from what aspect the evaluation has been performed, even if the category of evaluation is chosen.

### A Variant Embodiment

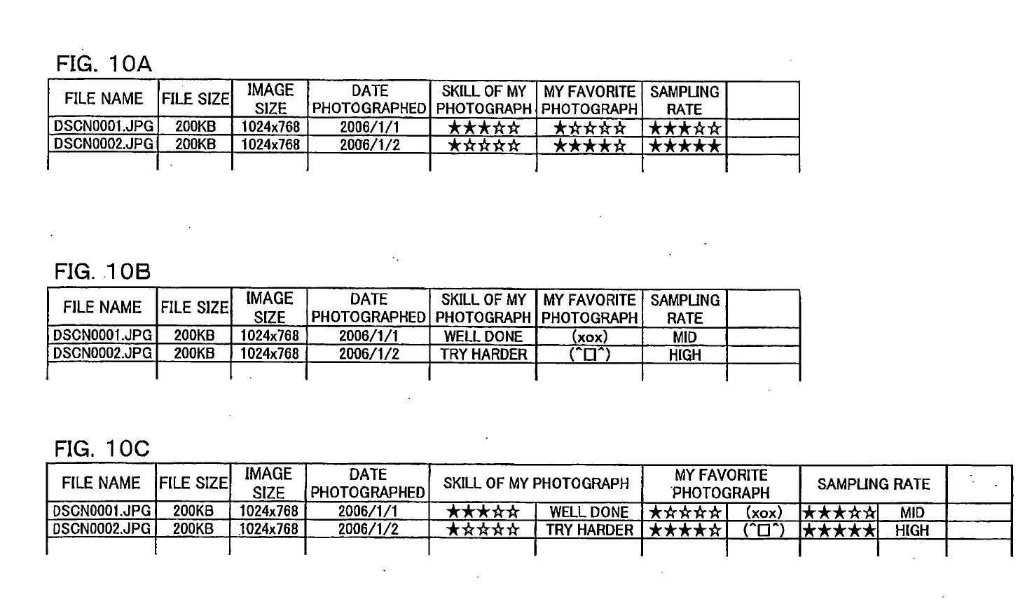

In the above description, an example was shown in which a single category of evaluation was designated for a single file, as shown in FIG. 3. On the other hand the concept has already been described of it being possible, for a single file, to establish ranking and rating comments in correspondence therewith for a plurality of categories of evaluation. In FIGS. 10A, 10B, and 10C a plurality of categories of evaluation are designated for a single file; and these figures show examples of list display of the results of ranking assignment in this case. FIGS. 10A through 10C show an example in which the three categories of evaluation “Skill of My Photograph”, “My Favorite Photograph”, and “Sampling Rate” are designated.

FIG. 10A shows an example in which the rankings for each category of evaluation are displayed by numbers of stars. And the rating comments of FIG. 10B are shown both by texts and by designs (icons). Whether the rating comments are shown by texts or by icons is determined by their categories of evaluation. In other words, it is determined by whether their category of evaluation is one for which the rating comments have been determined by texts, or is one for which the rating comments have been determined by designs (icons).

And FIG. 10C shows an example in which the rankings are determined both by numbers of stars and by rating comments. When this is done, it becomes simple and easy to understand according to what aspect each of the plurality of categories of evaluation has been evaluated. It should be understood that it is possible to arrange for the display with numbers of stars in FIG. 10A and the display with rating comments in FIG. 10B to be changed over appropriately according to a command from the user. Moreover, it would also be acceptable to arrange for the displays including FIG. 10C to be changed over appropriately in this manner.

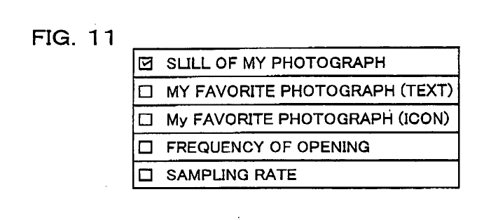

It should be understood that, if a plurality of categories of evaluation are set, then it will be acceptable to provide a display like that of FIG. 11 in the step S15 of FIG. 5 explained above. FIG. 11 shows an example of a display for selecting from among a plurality of categories of evaluation. When the display of FIG. 11 appears, the user selects the required categories of evaluation by making check mark in the check boxes that correspond to these required categories of evaluation. Thereafter, it will suffice to repeat the processing of the steps S14 through S17 for each of the plurality of categories of evaluation that have been selected.

In the embodiment described above, an example was shown in which different rating comments were established in correspondence to each of a plurality of rankings. However, it would also be acceptable to arrange for them to be established in correspondence only to the category of evaluation. To put this in another manner, it would also be acceptable to arrange for the rating comments for a plurality of rankings all to have the same category of evaluation title. Or, it would also be acceptable simply to append a number 1 through 5 or a letter A through E to the category of evaluation title. This is because, if the category of evaluation title is known, sometimes it is only possible to evaluate a file with a number of stars.

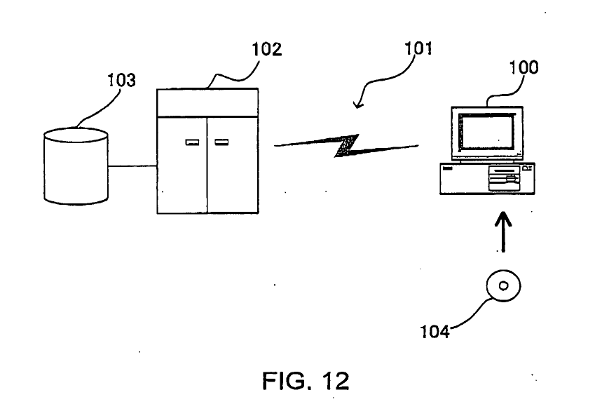

It should be understood that the program that has been explained in the above description of an embodiment may be supplied via a recording medium such as a CD-ROM or the like, or via a data signal such as the internet or the like. FIG. 12 is a figure showing such a situation. The computer 100 receives supply of a program via a CD-ROM 104. Furthermore, the computer 100 is endowed with a function of connection to a communication line 101. A computer 102 is a server computer that supplies the program described above, and stores the program upon a recording medium such as a hard disk 103 or the like. The communication line 101 is a communication line such as the internet or the like, or a dedicated communication line or the like. And the computer 102 reads out the program using the hard disk 103, and transmits this program via the communication line 101 to the computer 100. In other words, the program is embodied upon a carrier wave as a data signal, and is transmitted via the communication line 101. In this manner, the program may be supplied as a computer program product that can be read in by a computer in various different modes, such as a recording medium or a data signal (carrier wave) or the like.

It should be understood that it would also be acceptable to endow an electronic device like a digital camera or a portable telephone handset or the like with a function of ranking assignment like that described above. In this type of case, the program described above would be installed upon such an electronic device from the beginning. However, it would also be acceptable to arrange to supply such a program via a recording medium such as a flash memory or the like, or via a communication line, in a manner similar to which in the case of the computer 100.

The above described embodiments are examples, and various modifications can be made without departing from the scope of the invention.

What is claimed is:

1. An electronic device, comprising:
a comment appending unit that appends a desired comment to each of a plurality of rankings prepared for assigning a ranking to a data item; and
a correspondence establishment unit that establishes correspondence between the data item, and one of the plurality of rankings and the comment corresponding to the one of the plurality of rankings.

2. An electronic device according to claim 1, further comprising:
a category of evaluation designation unit that designates, for the data item, a category of evaluation for which a plurality of rankings can be assigned, wherein
the comment appending unit appends the comment to each of the rankings of this designated category of evaluation.

3. An electronic device according to claim 1, further comprising:
a category of evaluation designation unit that designates, for the data item, a plurality of categories of evaluation for each of which a plurality of rankings can be assigned, wherein
the comment appending unit appends the comment to each of the rankings of each of these designated categories of evaluation.

4. An electronic device according to claim 1, wherein
the data item to which the ranking can be assigned is a file that can be handled by a computer.

5. An electronic device according to claim 1, wherein
the comment appending unit appends the desired comment as text according to text input from the user.

6. An electronic device according to claim 1, wherein
the comment appending unit appends the desired comment as an icon according to designation of an icon from the user.

7. An electronic device according to claim 1, further comprising:
a display unit that displays information specifying the data item, the ranking established in correspondence with the data item, and the comment appended to the ranking.

8. An electronic device according to claim 3, further comprising:
a display unit that displays information specifying the data item, the plurality of categories of evaluation designated for the data item, and the rankings established in correspondence with each of the plurality of categories of evaluation.

9. A computer-readable computer program product containing a ranking assignment program, the ranking assignment program comprising:
a first instruction that appends a desired comment to each of a plurality of rankings prepared for assigning a ranking to a data item; and
a second instruction that establishes correspondence between the data item, and one of the plurality of rankings and the comment corresponding to the one of the plurality of rankings.

10. A computer program product according to claim 9, wherein:
the computer program further comprises a third instruction that designates, for the data item, a category of evaluation for which a plurality of rankings can be assigned; and
the second instruction appends the comment to each of the rankings of this designated category of evaluation.

11. A computer program product according to claim 9, wherein:
the computer program further comprises a third instruction that designates, for the data item, a plurality of categories of evaluation for each of which a plurality of rankings can be assigned; and
the second instruction appends the comment to each of the rankings of each of these designated categories of evaluation.

12. A method of data ranking used in an electronic device, comprising:
appending a desired comment to each of a plurality of rankings prepared for assigning a ranking to a data item; and
establishing correspondence between the data item, and one of the plurality of rankings and the comment corresponding to the one of the plurality of rankings.
